(19) United States
(12) Patent Application Publication
(10) Pub. No.: US 2025/0005354 A1
(43) Pub. Date: Jan. 2, 2025

(54) Learning Strides in Convolutional Neural Networks

(71) Applicant: Google LLC, Mountain View, CA (US)

(72) Inventors: Neil Zeghidour, Paris (FR); Rachid Riad, Paris (FR); Olivier Teboul, Paris (FR); David Grangier, Mountain View, CA (US)

(21) Appl. No.: 18/698,691

(22) PCT Filed: Oct. 5, 2022
(86) PCT No.: PCT/US2022/077603

§ 371 Date: Apr. 4, 2024

Related U.S. Application Data
(60) Provisional application No. 63/262,119, filed on Oct. 5, 2021.

(51) Int. Cl. G06N 3/08

(52) U.S. Cl. CPC G06N 3/08

(57) ABSTRACT

A method of training a machine learning model, includes receiving training data for the machine learning model, wherein the training data comprises a plurality of batches. The method also includes applying a downsampling layer of the machine learning model to the plurality of batches of the training data to determine a stride comprising a learnable parameter for the downsampling layer. Applying the downsampling layer of the machine learning model to a batch of the training data includes projecting an input in a spatial domain to a Fourier domain, constructing a mask in the Fourier domain based on a current value of the stride and dimensions of the input, applying the mask as a low-pass filter to the projected input to produce a tensor in the Fourier domain, cropping the tensor based on the mask, and transforming the cropped tensor to the spatial domain.

### CROSS-REFERENCE TO RELATED DISCLOSURE

This application claims priority to U.S. Provisional Patent Application No. 63/262,119, filed on Oct. 5, 2021, which is incorporated herein by reference in its entirety.

### BACKGROUND

Convolutional neural networks (CNNs) have been used across neural architecture across a wide range of tasks, including image classification, audio pattern recognition, text classification, machine translation, and speech recognition. Convolution layers, which are the building block of CNNs, may project input features to a higher-level representation while preserving their resolution.

### SUMMARY

In an embodiment, a method of training a machine learning model includes receiving training data for the machine learning model, wherein the training data comprises a plurality of batches. The method also includes applying a downsampling layer of the machine learning model to the plurality of batches of the training data to determine a stride comprising a learnable parameter for the downsampling layer, wherein applying the downsampling layer of the machine learning model to a batch of the training data comprises: projecting an input in a spatial domain to a Fourier domain; constructing a mask in the Fourier domain based on a current value of the stride and dimensions of the input; applying the mask as a low-pass filter to the projected input to produce a tensor in the Fourier domain: cropping the tensor based on the mask; and transforming the cropped tensor to the spatial domain.

In another embodiment, a system of training a machine learning model includes a computing device configured to receive the training data for the machine learning model, wherein the training data comprises a plurality of batches, The computing device is further configured to apple a downsampling layer of the machine learning model to the plurality of batches of the training data to determine a stride comprising a learnable parameter for the downsampling layer, wherein applying the downsampling layer of the machine learning model to a batch of the training data comprises: projecting an input in a spatial domain to a Fourier domain; constructing a mask in the Fourier domain based on a current value of the stride and dimensions of the input: applying the mask as a low-pass filter to the projected input to produce a tensor in the Fourier domain; cropping the tensor based on the mask; and transforming the cropped tensor to the spatial domain.

In another embodiment, a non-transitory computer readable medium is provided which includes program instructions executable by at least one processor to cause the at least one processor to perform functions of training a machine learning model. The functions include receiving training data for the machine learning model, wherein the training data comprises a plurality of batches. The functions also include applying a downsampling layer of the machine learning model to the plurality of batches of the training data to determine a stride comprising a learnable parameter for the downsampling layer, wherein applying the downsampling layer of the machine learning model to a batch of the training data comprises: projecting an input in a spatial domain to a Fourier domain; constructing a mask in the Fourier domain based on a current value of the stride and dimensions of the input; applying the mask as a low-pass filter to the projected input to produce a tensor in the Fourier domain; cropping the tensor based on the mask; and transforming the cropped tensor to the spatial domain.

In a further embodiment, a system is provided that includes means of training a machine learning model. The system includes means for receiving training data for the machine learning model, wherein the training data comprises a plurality of batches. The system also includes means for applying a downsampling layer of the machine learning model to the plurality of batches of the training data to determine a stride comprising a learnable parameter for the downsampling layer, wherein applying the downsampling layer of the machine learning model to a batch of the training data comprises: projecting an input in a spatial domain to a Fourier domain; constructing a mask in the Fourier domain based on a current value of the stride and dimensions of the input applying the mask as a low-pass filter to the projected input to produce a tensor in the Fourier domain; cropping the tensor based on the mask; and transforming the cropped tensor to the spatial domain.

In an embodiment, a method of applying a machine learning model that includes a downsampling layer with a learned value of a stride is provided. The method includes projecting an input provided to the downsampling layer of the machine learning model in a spatial domain to a Fourier domain. The method also includes constructing a mask in the Fourier domain based on the learned value of the stride of the downsampling layer of the machine learning model and dimensions of the input. The method further includes applying the mask as a low-pass filter to the projected input to produce a tensor in the Fourier domain. The method additionally includes cropping the tensor based on the mask. The method further includes transforming the cropped tensor to the spatial domain.

In another embodiment, a system of applying a machine learning model that includes a downsampling layer with a learned value of a stride is presented. The system includes a computing device configured to project an input provided to the downsampling layer of the machine learning model in a spatial domain to a Fourier domain. The computing device is further configured to construct a mask in the Fourier domain based on the learned value of the stride of the downsampling layer of the machine learning model and dimensions of the input. The computing device is also configured to apply the mask as a low-pass filter to the projected input to produce a tensor in the Fourier domain. The computing device is additionally configured to crop the tensor based on the mask. The computing device is further configured to transform the cropped tensor to the spatial domain.

In another embodiment, a non-transitory computer readable medium is provided which includes program instructions executable by at least one processor to cause the at least one processor to perform functions of applying a machine learning model that includes a downsampling layer with a learned value of a stride. The functions include projecting an input provided to the downsampling layer of the machine learning model in a spatial domain to a Fourier domain. The functions further include constructing a mask in the Fourier domain based on the learned value of the stride of the downsampling layer of the machine learning model and dimensions of the input. The functions also include applying the mask as a low-pass filter to the projected input to produce a tensor in the Fourier domain. The functions additionally include cropping the tensor based on the mask. The functions further include transforming the cropped tensor to the spatial domain.

In a further embodiment, a system is provided that includes means of applying a machine learning model that includes a downsampling layer with a learned value of a stride. The system includes means for projecting an input provided to the downsampling layer of the machine learning model in a spatial domain to a Fourier domain. The system also includes means for constructing a mask in the Fourier domain based on the learned value of the stride of the downsampling layer of the machine learning model and dimensions of the input. The system further includes means for applying the mask as a low-pass filter to the projected input to produce a tensor in the Fourier domain. The system additionally includes means for cropping the tensor based on the mask. The system also includes means for transforming the cropped tensor to the spatial domain.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 is a diagram illustrating training and inference phases of a machine learning model, in accordance with example embodiments.

FIG. 2 is a flowchart of a method, in accordance with example embodiments.

FIG. 3 is a flowchart of a method, in accordance with example embodiments.

FIG. 4 shows DiffStride forward and backward pass, using a single-channel image.

FIG. 5 illustrates an algorithm, in accordance with example embodiments.

FIG. 6a illustrates an example residual block with a strided convolution, in accordance with example embodiments.

FIG. 6b illustrates an example residual block with a shared DiffStride layer, in accordance with example embodiments.

FIG. 7 illustrates the learning dynamics of DiffStride on a dataset, in accordance with example embodiments.

FIG. 8 is a table, in accordance with example embodiments.

FIG. 9 is a table, in accordance with example embodiments.

FIG. 10a is a chart, in accordance with example embodiments.

FIG. 10b is a chart, in accordance with example embodiments.

FIG. 10c is a chart, in accordance with example embodiments.

FIG. 11 is a table, in accordance with example embodiments.

FIG. 12 is a chart, in accordance with example embodiments.

FIG. 13 is a table, in accordance with example embodiments.

FIG. 14a is a chart, in accordance with example embodiments.

FIG. 14b is a chart, in accordance with example embodiments.

FIG. 15a is a chart, in accordance with example embodiments.

FIG. 15b is a chart, in accordance with example embodiments.

FIG. 16 is a table, in accordance with example embodiments.

FIG. 17a is a table, in accordance with example embodiments.

FIG. 17b is a table, in accordance with example embodiments.

FIG. 18a is a table, in accordance with example embodiments.

FIG. 18b is a table, in accordance with example embodiments.

FIG. 19 is a table, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

Convolutional neural networks may contain several downsampling operators, such as strided convolutions or pooling layers. These layers may progressively reduce the resolution of intermediate representations, providing some shift-invariance while reducing the computational complexity of the whole architecture. An important hyperparameter of these layers is their stride: the integer factor of downsampling. As strides are not differentiable, finding the optimal value for each stride hyperparameter may be difficult and time consuming, particularly as the search as the search space grows exponentially with the number of downsampling layers.

The present disclosure includes a learnable stride downsampling layer to learn the size of a cropping mask in a Fourier domain, which may perform resizing in a differentiable way. This learnable stride may be used as a replacement for standard downsampling layers. Compared to machine learning models that use standard downsampling layers (with manually determined stride hyperparameters), a machine learning model that uses a learnable stride downsampling layer as described herein may be easier to implement and may generate predictions more accurately due to the learnable stride downsampling layer automatically determining an optimal value for the stride hyperparameter during training through backpropagation.

### II. Example Systems and Methods

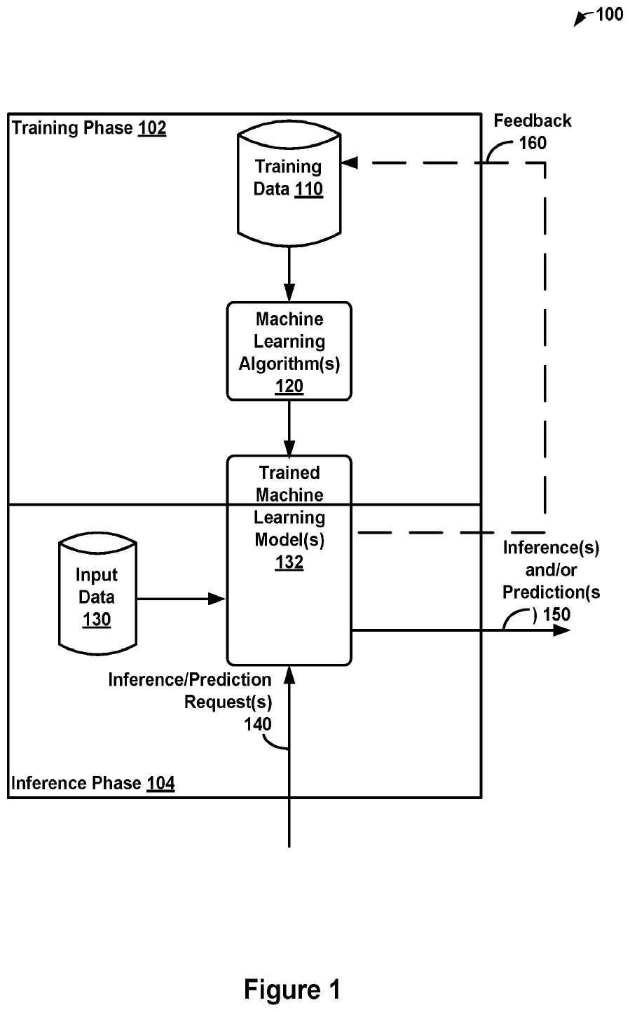

FIG. 1 shows diagram 100 illustrating a training phase 102 and an inference phase 204 of trained machine learning model(s) 132, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 1 shows training phase 102 where one or more machine learning algorithms 120 are being trained on training data 110 to become trained machine learning model 132. Producing trained machine learning model(s) 132 during training phase 102 may involve determining one or more hyperparameters, such as one or more stride values for one or more layers of a machine learning model as described herein. Then, during inference phase 104, trained machine learning model 132 can receive input data 130 and one or more inference/prediction requests 140 (perhaps as part of input data 130) and responsively provide as an output one or more inferences and/or predictions 150. The one or more inferences and/or predictions 150 may be based in part on one or more learned hyperparameters, such as one or more learned stride values for one or more layers of a machine learning model as described herein

As such, trained machine learning model(s) 132 can include one or more models of one or more machine learning algorithms 120. Machine learning algorithm(s) 120 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 120 and/or trained machine learning model(s) 132 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 120 and/or trained machine learning model(s) 132. In some examples, trained machine learning model(s) 132 can be trained, reside and execute to provide inferences on a particular computing device, and/or otherwise can make inferences for the particular computing device.

During training phase 102, machine learning algorithm(s) 120 can be trained by providing at least training data 110 as training input using unsupervised, supervised, semi-supervised, and/or reinforcement learning techniques. Unsupervised learning involves providing a portion (or all) of training data 110 to machine learning algorithm(s) 120 and machine learning algorithm(s) 120 determining one or more output inferences based on the provided portion (or all) of training data 110. Supervised learning involves providing a portion of training data 110 to machine learning algorithm(s) 120, with machine learning algorithm(s) 120 determining one or more output inferences based on the provided portion of training data 110, and the output inference(s) are either accepted or corrected based on correct results associated with training data 110. In some examples, supervised learning of machine learning algorithm(s) 120 can be governed by a set of rules and/or a set of labels for the training input, and the set of rules and/or set of labels may be used to correct inferences of machine learning algorithm(s) 120.

Semi-supervised learning involves having correct results for part, but not all, of training data 110. During semi-supervised learning, supervised learning is used for a portion of training data 110 having correct results, and unsupervised learning is used for a portion of training data 110 not having correct results.

Reinforcement learning involves machine learning algorithm(s) 120 receiving a reward signal regarding a prior inference, where the reward signal can be a numerical value. During reinforcement learning, machine learning algorithm(s) 120 can output an inference and receive a reward signal in response, where machine learning algorithm(s) 120 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 120 and/or trained machine learning model(s) 132 can be trained using other machine learning techniques, including but not limited to, incremental learning and curriculum learning.

In some examples, machine learning algorithm(s) 120 and/or trained machine learning model(s) 132 can use transfer learning techniques. For example, transfer learning techniques can involve trained machine learning model(s) 132 being pre-trained on one set of data and additionally trained using training data 110. More particularly, machine learning algorithm(s) 120 can be pre-trained on data from one or more computing devices and a resulting trained machine learning model provided to computing device CD1, where CD1 is intended to execute the trained machine learning model during inference phase 104. Then, during training phase 102, the pre-trained machine learning model can be additionally trained using training data 110. This further training of the machine learning algorithm(s) 120 and/or the pre-trained machine learning model using training data 110 of CD1's data can be performed using either supervised or unsupervised learning. Once machine learning algorithm(s) 120 and/or the pre-trained machine learning model has been trained on at least training data 110, training phase 102 can be completed. The trained resulting machine learning model can be utilized as at least one of trained machine learning model(s) 132.

In particular, once training phase 202 has been completed, trained machine learning model(s) 132 can be provided to a computing device, if not already on the computing device. Inference phase 104 can begin after trained machine learning model(s) 132 are provided to computing device CD1.

During inference phase 104, trained machine learning model(s) 132 can receive input data 130 and generate and output one or more corresponding inferences and/or predictions 150 about input data 130. As such, input data 130 can be used as an input to trained machine learning model(s) 132 for providing corresponding inference(s) and/or prediction(s) 150. For example, trained machine learning model(s) 132 can generate inference(s) and/or prediction(s) 1150 in response to one or more inference/prediction requests 240. In some examples, trained machine learning model(s) 132 can be executed by a portion of other software. For example, trained machine learning model(s) 132 can be executed by an inference or prediction daemon to be readily available to provide inferences and/or predictions upon request. Input data 130 can include data from computing device CD1 executing trained machine learning model(s) 132 and/or input data from one or more computing devices other than CD1.

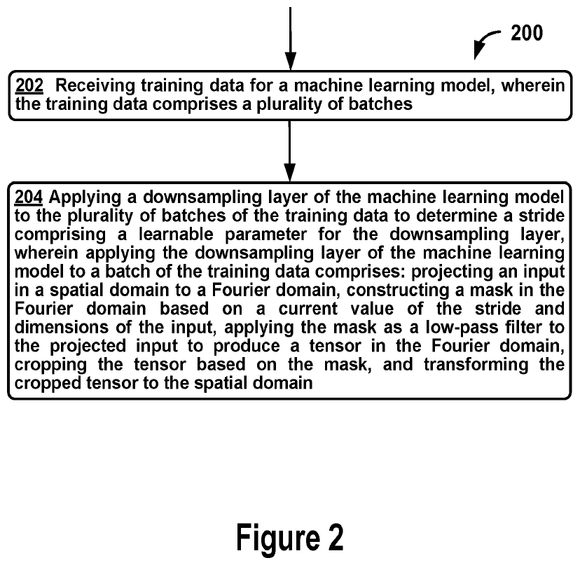

FIG. 2 is a flow chart of method 200 of training a machine learning model, in accordance with example embodiments. Method 200 may be executed by one or more processors.

At block 202, method 200 may include receiving training data for the machine learning model, wherein the training data comprises a plurality of batches.

At block 204, method 200 may include applying a downsampling layer of the machine learning model to the plurality of batches of the training data to determine a stride comprising a learnable parameter for the downsampling layer, where applying the downsampling layer of the machine learning model to a batch of the training data comprises: projecting an input in a spatial domain to a Fourier domain, constructing a mask in the Fourier domain based on a current value of the stride and dimensions of the input, applying the mask as a low-pass filter to the projected input to produce a tensor in the Fourier domain, cropping the tensor based on the mask, and transforming the cropped tensor to the spatial domain.

In some embodiments, applying the downsampling layer of the machine learning model to the batch of the training data may further comprise before cropping the tensor based on the mask, applying a stop gradient operator to the mask.

In some embodiments, the mask may be further based on a smoothing hyperparameter.

In some embodiments, the stride may comprise an additional learnable parameter, where the input comprises a tensor having at least a first dimension and a second dimension, where cropping the tensor based on the mask results in the cropped tensor having at least dimensions of (i) the first dimension of the input divided by the learnable parameter plus twice the value of the smoothing hyperparameter and (ii) the second dimension of the input divided by the additional learnable parameter plus twice the value of the smoothing hyperparameter.

In some embodiments, the method may further comprise applying one or more additional downsampling layers of the machine learning model to one or more additional inputs for the plurality of batches of the training data to determine one or more additional strides each comprising an additional learnable parameter for the one or more additional downsampling layers, wherein applying each additional downsampling layer comprises applying an additional mask based on an additional smoothing hyperparameter, where each of the smoothing hyperparameter and the additional smoothing hyperparameters have a same value.

In some embodiments, the method may further comprise applying an additional downsampling layer of the machine learning model to an additional input for the plurality of batches of the training data to determine an additional stride comprising an additional learnable parameter for the downsampling layer, where the applying the additional downsampling layer comprises constructing an additional mask based on a current value of the additional stride and dimensions of the additional input, where the current value of the stride differs from the current value of the additional stride.

In some embodiments, the stride may comprise an additional learnable parameter, where the input comprises a tensor including a first dimension and a second dimension, where the learnable parameter has a value between one and the first dimension, and wherein the additional learnable parameter has a value between one and the second dimension.

In some embodiments, the input may comprise a tensor including a first dimension and a second dimension, wherein the learnable parameter corresponds to the stride in the first dimension and the second dimension, and wherein the learnable parameter has a value between one and the lesser of the first dimension and the second dimension.

In some embodiments, the method may further comprise applying a convolution layer without stride of the machine learning model to an additional input for the plurality of batches of the training data to determine the stride comprising the learnable parameter for the downsampling layer, where the convolution layer is directly followed by the downsampling laver.

In some embodiments, applying the mask as a low-pass filter to the projected input to produce a tensor in the Fourier domain may comprise calculating, using element-wise multiplication between the low-pass filter and the projected input, the tensor in the Fourier domain.

In some embodiments, projecting the input in the spatial domain to the Fourier domain may comprise computing a discrete Fourier transform of the input from the spatial domain.

In some embodiments, transforming the cropped tensor to the spatial domain may comprise computing an inverse discrete Fourier transform of the cropped tensor in the Fourier domain.

In some embodiments, the method may further comprise, before applying the downsampling layer of the machine learning model to the plurality of batches of the training data, applying a convolutional layer without strides.

In some embodiments, the method may further comprise, for a first batch of the training data, generating a random value for the current value of the stride.

In some embodiments, the method may further comprise determining the current value of the stride for a second batch of the training data based on calculating, based on backpropagation and the random value generated for the first batch of the training data, a refined current value of the stride.

In some embodiments, the input may be two-dimensional, where the mask in the Fourier domain is an outer product of a horizontal mask and a vertical mask, where the horizontal mask and the vertical mask are derived from adaptive span attention.

In some embodiments, the input may be three-dimensional, where the mask in the Fourier domain is an outer product of three one-dimensional masks derived from adaptive span attention.

In some embodiments, the input may have a plurality of channels, where applying the mask as the low-pass filter to the projected input to produce the tensor in the Fourier domain comprises applying the mask to each of the plurality of channels.

In some embodiments, applying the downsampling layer of the machine learning model to a batch of the training data may further comprise using a complexity regularizer comprising a regularization weight.

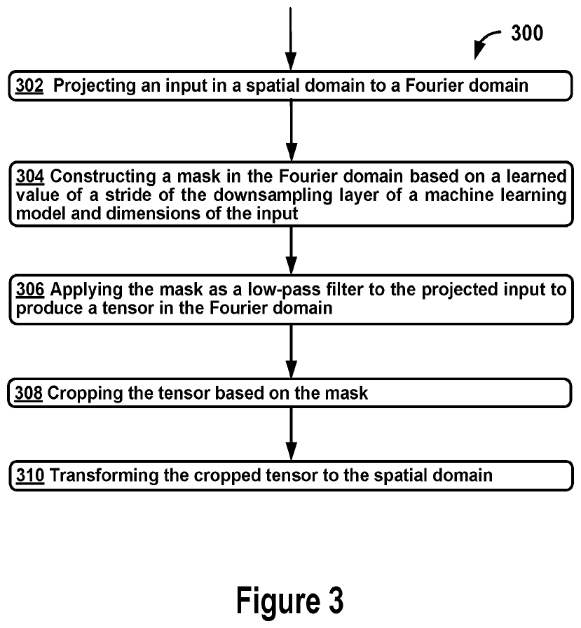

FIG. 3 is a flow chart of method 300 of applying a machine learning model that includes a downsampling layer, in accordance with example embodiments. Method 300 may be executed by one or more processors.

At block 302, method 300 may include projecting an input provided to the downsampling layer of the machine learning model in a spatial domain to a Fourier domain.

At block 304, method 300 may include constructing a mask in the Fourier domain based on the learned value of the stride of the downsampling layer of the machine learning model and dimensions of the input.

At block 306, method 300 may include applying the mask as a low-pass filter to the projected input to produce a tensor in the Fourier domain.

At block 308, method 300 may include cropping the tensor based on the mask.

At block 310, method 300 may include transforming the cropped tensor to the spatial domain.

In some embodiments, the method may also comprise classifying one or more images based at least in part on the transformed cropped tensor.

In some embodiments, the method may also include classifying audio input data based at least in part on the transformed cropped sensor.

In some embodiments, a system may include a processor and a non-transitory computer-readable medium having stored thereon instructions that, when executed by the processor, cause the processor to perform operations in accordance with any of methods described above and/or below:

In some embodiments, a non-transitory computer-readable medium having stored thereon instructions that, when executed by a computing device, may cause the computing device to perform operations in accordance with any of the methods described above and/or below.

Convolutional neural networks may contain several downsampling operators, such as strided convolutions and/or pooling layers, which may progressively reduce the resolution of intermediate representations. This may provide some shift-invariance while reducing the computational complexity of the whole architecture. A critical hyperparameter of such layers is their stride. The stride may refer to the integer factor of downsampling. As strides are typically not differentiable, finding the best configuration either requires cross-validation or discrete optimization (e.g. architecture search), which may rapidly become prohibitive as the search space grows exponentially with the number of downsampling layers. Hence, exploring this search space by gradient descent may allow finding better configurations at a lower computational cost. This work introduces DiffStride, a downsampling layer with learnable strides. A DiffStride layer may learn the size of a cropping mask in the Fourier domain, which may effectively performs resizing in a differentiable way. Experiments on audio and image classification show the generality and effectiveness of this solution: DiffStride may be used as a drop-in replacement to standard downsampling layers and outperform them. In particular, DiffStride may be integrated into a ResNet architecture, which may allow maintaining consistent high performance on CIFAR10, CIFAR100 and ImageNet even when training starts from poor random stride configurations. CIFAR10, CIFAR100, and ImageNet are datasets including images and labels corresponding to objects (or lack thereof) in the corresponding image. Moreover, formulating strides as learnable variables may allow introduction of a regularization term that controls the computational complexity of the architecture. This regularization term may allow for a tradeoff between accuracy and efficiency, as shown herein on ImageNet.

Convolutional neural networks (CNNs) may be a widely used neural architecture across a wide range of tasks, including image classification, audio pattern recognition, text classification, machine translation and speech recognition. Convolution layers, which may be the building block of CNNs, project input features to a higher-level representation while preserving the resolution of the input features. Convolutional layers may be combined with non-linearities and normalization layers, which may allow for learning rich mappings at a constant resolution, e.g. autogressive image synthesis. However, many tasks may infer high-level low-resolution information (e.g., identity of a speaker, presence of a face) by integrating over low-level, high-resolution measurements (e.g., waveform, pixels). This integration may involve extracting the correct features, discarding information that may be irrelevant over several downsampling steps. To that end, pooling layers and strided convolutions may reduce the resolution of their inputs, providing various benefits. First, the pooling layers and strided convolutions may act as a bottleneck that forces features to focus on information relevant to the task at hand. Second, pooling layers such as low-pass filters may improve shift-invariance. Third, a reduced resolution may imply a reduced number of floating-point operations and a higher receptive field in the subsequent layers.

Pooling layers can usually be decomposed into two basic steps: (1) computing local statistics densely over the whole input (2) sub-sampling these statistics by an integer striding factor. In some examples, integer strides may reduce resolution too quickly (e.g. a (2,2) striding reduces the output size by 75%). Fractional max-pooling may allow for fractional (i.e. rational) strides, which may facilitate the integration of more downsampling layers into a network. Spectral pooling may crop its inputs in the Fourier domain and perform downsampling with fractional strides while emphasizing lower frequencies.

While fractional strides may give more flexibility in designing downsampling layers, they may also increase the size of an already gigantic search space. Indeed, as strides are hyperparameters, finding the best combination may need cross-validation or architecture search, which may rapidly become infeasible as the number of configurations grows exponentially with the number of downsampling layers. In some implementations, the strides may not be determined experimentally. In further implementations, a neural network that learns a resizing function for natural images may be used. However, a scaling factor (e.g., the stride) may still be used for cross-validation. Thus, the nature of strides as hyperparameters—rather than trainable parameters—may hinder the discovery of convolutional architectures and learning strides by backpropagation would unlock a virtually infinite search space.

Provided herein are downsampling layers that learns its strides jointly with the rest of the network. As described herein, the downsampling in the spatial domain is cast as cropping in the frequency domain. However, and unlike, rather than cropping with a fixed bounding box controlled by a striding hyperparameter, DiffStride may learn the size of its cropping box by backpropagation. To do so, a 2D version of an attention window with learnable size is proposed by for language modeling. On audio classification tasks, using DiffStride as a drop-in replacement to strided convolutions may improve performance overall while providing interpretability on the optimal per-task receptive field. By integrating DiffStride into a ResNet, the model may converge to the best performance obtained with properly cross-validated stride when trained on CIFAR and ImageNet, even when initializing strides randomly. Moreover, casting strides as learnable parameters may facilitate usage of a regularization term that directly minimizes computation and memory usage.

Background on spatial and spectral pooling will first be provided followed by a description of DiffStride for learning strides of downsampling layers. Two dimensional CNNs will be the focus herein since they are generic enough to be used for image and audio processing (taking time-frequency representations as inputs). However, these methods are equally applicable to the 1D (e.g. time-series) and 3D (e.g. video) cases.

For example, let x∈ [symbol] , its Discrete Fourier Transform (DFT) y= [symbol] (x)∈ [symbol] is obtained through the decomposition on a fixed set of basis filters:

$${( x )}_{mn} = \frac{1}{√ HW} {\sum }_{h = 0}^{H - 1} {\sum }_{w = 0}^{W - 1} {x}_{hw} {e}^{- 2 π i ( \frac{mh}{H} + \frac{nw}{W} )} , \\ ∀ m ∈ \{ 0 , … , H - 1 \} , ∀ n ∈ \{ 0 , … , W - 1 \} .$$

The DFT transformation is linear and its inverse is given by its conjugate [symbol] (·)⁻¹= [symbol] (·)*. The Fourier transform of a real-valued signal x∈ [symbol] being conjugate symmetric (Hermitian-symmetry), x may be reconstructed from the positive half frequencies for the width dimension and omit the negative frequencies (yₘₙ=y*_{(H-m)mod H,(W-n)mod W}).

In addition, the DFT and its inverse are differentiable with regard to their inputs and the derivative of the DFT (resp. inverse DFT) is its conjugate linear operator, i.e. the inverse DFT (resp. DFT).

More formally, if [symbol] : [symbol] → [symbol] is considered as a loss taking as input the Fourier representation y, the gradient of [symbol] can be computed with regard to x, by using the inverse DFT:

$$x ∈ , y = ( x ) , \frac{\partial ℒ}{\partial x} = {*}^{} ( \frac{\partial L}{\partial y} ) = {- 1}^{} ( \frac{\partial L}{\partial y} ) .$$

L is the total number of convolution layers in a CNN architecture and each layer is indexed by l. The ∘ symbol represents the element-wise product between two tensors, └·┘ is the floor operation and ⊗ the outer product between two vectors. S represents the stride parameters, and sg is the stop gradient operator, defined has the identity function during forward pass and with zero partial derivatives.

A basic mechanism for downsampling representations in a CNN is strided convolutions which jointly convolve inputs and finite impulse response filters and downsample the output. Alternatively, both operations can be disentangled by first applying a non-strided convolution followed by a pooling operation that computes local statistics (e.g. using an average, max) before downsampling. In both settings, downsampling does not benefit from the global structure of its inputs and can discard important information. Moreover, the integer nature of strides only allows for drastic reductions in resolution: a 2D-convolution with strides S=(2, 2) reduces the dimension of its inputs by 75%. Furthermore, stride configurations are cumbersome to explore as the number of stride combinations grows exponentially with the number of downsampling layers. This means that cross-validation can only explore a limited subset of the stride hyperparameter configurations. This limitation is likely to translate into lower performance, as mentioned above shows that an inappropriate choice of strides for a ResNet architecture can account for a drop of >18% in accuracy on CIFAR-100.

Energy of natural signals is typically not uniformly distributed in the frequency domain, with signals such as sounds, images, and surfaces concentrating most of the information in the lower frequencies. This observation may be built upon to introduce spectral pooling which alleviates the loss of information of spatial pooling, while enabling fractional downsizing factors. Spectral pooling also preserves low frequencies without aliasing, a known weakness of spatial/temporal convnets.

An input x∈ [symbol] and strides S=Sₕ, S_{w}∈[1, H)×[1, W) is considered. First, the DFT is computed y= [symbol] (x)∈ [symbol] , assuming that the center of this matrix is the DC component—the zero frequency. Then, a bounding box of size

$$⌊ \frac{H}{{S}_{h}} ⌋ \times ⌊ \frac{W}{{S}_{w}} ⌋$$

crops this matrix around its center to produce \tilde{y}∈

$${⌊ \frac{H}{{S}_{h}} ⌋ \times ⌊ \frac{W}{{S}_{w}} ⌋}^{} .$$

Finally, this output is brought back to the spatial domain with an inverse DFT:

$$\tilde{x} = ( \tilde{y} ) ∈ {⌊ \frac{H}{{S}_{h}} ⌋ \times ⌊ \frac{W}{{S}_{w}} ⌋}^{} .$$

In practice, x is typically a multi-channel input (i.e. x∈ [symbol] ) and the same cropping is applied to all channels. Moreover, since x is real-valued and thanks to Hermitian symmetry (see above for more details), only the positive half of the DFT coefficients are computed, which allows saving computation and memory while ensuring that the output % remains real-valued.

Unlike spatial pooling that uses integer strides, spectral pooling only requires integer output dimensions, which allows for much more fine-grained downsizing. Moreover, spectral pooling may act as a low-pass filter over the entire input, only keeping the lower frequencies i.e. the most relevant information in general and avoiding aliasing. However, and similarly to spatial pooling, spectral pooling is differentiable with respect to its inputs but not with respect to its strides. Thus, S may still need to be provided as hyperparameters for each downsampling layer. In this case, the search space is even bigger than with spatial pooling since strides are not constrained to integer values anymore.

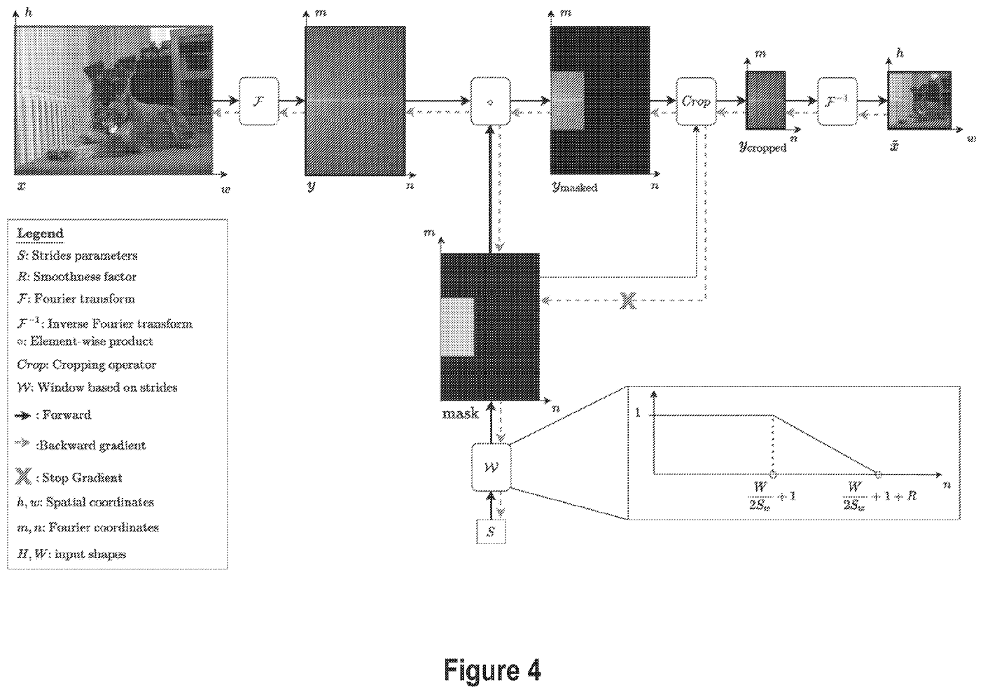

FIG. 4 shows DiffStride forward and backward pass, using a single-channel image. The positive half of DFT coefficients may be computed along the horizontal axis due to conjugate symmetry. The zoomed frame shows the horizontal mask mask_{(S}_{_{w}}_{,W,R)}^{w} (n). Here S=Sₕ, S_{w}=(2.6, 3.1).

To address the difficulty of searching stride parameters, provided herein is DiffStride, a downsampling layer that may allow spectral pooling to learn its strides through backpropagation.

To downsample x∈ [symbol] , DiffStride may perform cropping in the Fourier domain similarly to spectral pooling. However, instead of using a fixed bounding box, DiffStride may learn the box size via backpropagation. The learnable box W is parametrized by the shape of the input, a smoothness factor R and the strides. This mask W may be designed as the outer product between two differentiable 1D masking functions (depicted in the lower right corner of FIG. 4), one along the horizontal axis and one along the vertical axis.

These 1D masks can be directly derived from the adaptive attention span concepts to learn the attention span of self-attention models for natural language processing. Exploiting the conjugate symmetry of the coefficients, only positive frequencies along the horizontal axis are considered, while the vertical mask is mirrored around frequency zero. Therefore, the two masks may be defined as follows:

$${mask}_{( {S}_{h} , H , R )}^{h} ( m ) = min [ max [ \frac{1}{R} ( R + \frac{H}{2 {S}_{h}} - \vert \frac{H}{2} - m \vert ) , 0 ] , 1 ] , \\ m ∈ [ 0 , H ] \qquad Equation 3$$

$${mask}_{( {S}_{w} , W , R )}^{w} ( n ) = min [ max [ \frac{1}{R} ( R + \frac{W}{2 {S}_{w}} - \vert \frac{W}{2} - n \vert ) , 0 ] , 1 ] , \\ m ∈ [ 0 , W ] \qquad [ Equation 4 ]$$

Where S=(Sₕ, S_{w}) are the strides and R is a hyperparameter that controls the smoothness of the mask. The 2D differentiable mask W is built as the outer product between the two 1D masks:

$$( {S}_{h} , {S}_{w} , H , W , R ) = {mask}_{( {S}_{h} , H , R )}^{h} ⊗ {mask}_{( {S}_{w} , W , R )}^{w} \qquad Equation 5$$

[symbol] is used in two ways: (1) used in the Fourier representation of the inputs via an element-wise product, which performs low-pass filtering, and (2) used in the Fourier coefficients is cropped where the mask is zero (i.e. the output has dimensions

$$⌊ \frac{H}{{S}_{h}} + 2 \times R ⌋ \times ⌊ \frac{W}{{S}_{w}} + 2 \times R ⌋ ) .$$

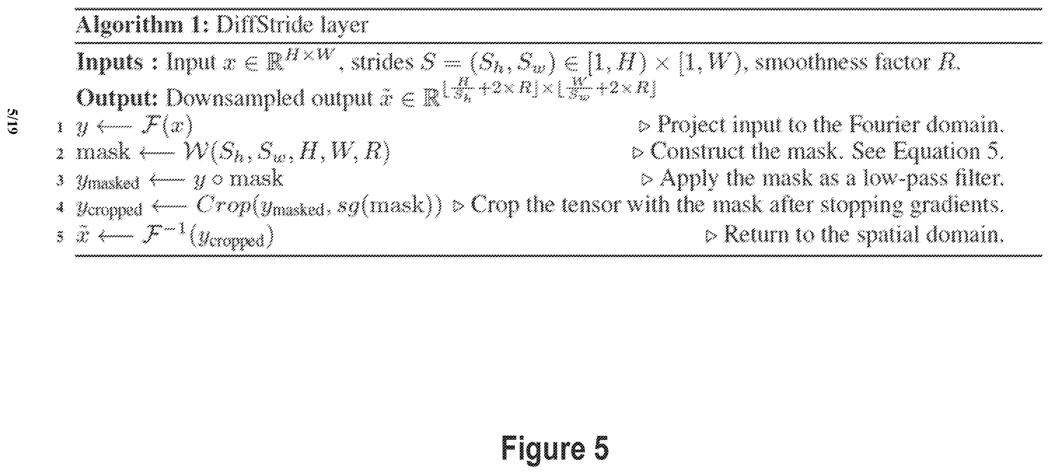

The first step is differentiable with respect to strides S, however the cropping operation is not. Therefore, a stop gradient operator is applied to the mask before cropping. This way, gradients can flow to the strides through the differentiable low-pass filtering operation, but not through the non-differentiable cropping. Finally, the cropped tensor is transformed back into the spatial domain using an inverse DFT. FIG. 5 illustrates an algorithm, in accordance with example embodiments. All these steps are summarized by FIG. 5 and illustrated on a single channel image in the FIG. 4.

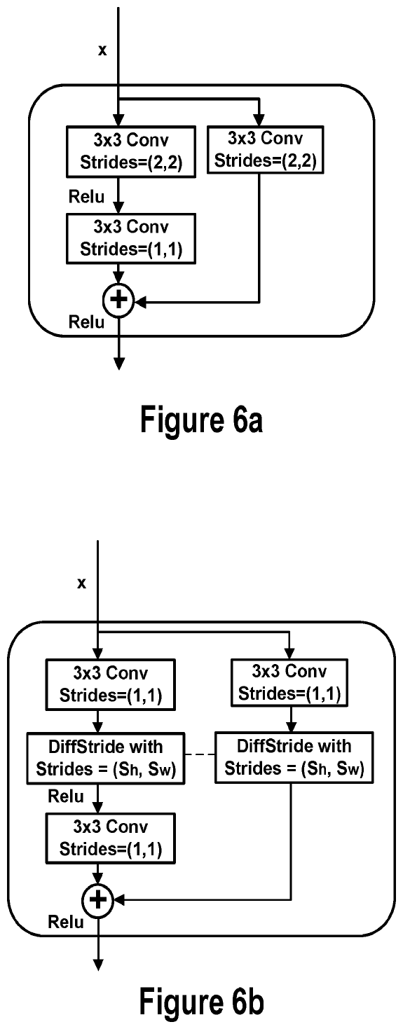

During training, strides S=(Sₕ, S_{w}) are constrained to remain in [1, H)×[1, W). When x is a multi-channel input (i.e., x∈ [symbol] ), the same strides S are learned for all channels to ensure uniform spatial dimensions across channels. In spatial and spectral pooling, strides are typically tied along the spatial axes (i.e., S_{w}=Sₕ), which DiffStride may also be able to do by sharing a single learnable stride on both dimensions. However, experiments in Section 3 show that learning specific strides for the vertical and horizontal axis is beneficial, not only when processing time-frequency representations of audio, but also—more surprisingly—when classifying natural images. Adding a hyperparameter R to each downsampling layer could conflict with the goal of removing strides as hyperparameters. Thus, not only is a single R value used for all layers, but no significant impact of this choice was observed and all the experiments used R=4. While the focus is on the 2D case, using a single 1D mask allows deriving DiffStride in 1D CNNs, while performing the outer product between three 1D masks allows applying DiffStride to 3D inputs. Unlike systems that only feed outputs of the l^{th} layer to the (l+1)^{th}, ResNets introduce skip-connections that operate in parallel to the main branch. ResNets stack two types of blocks: (1) identity blocks that maintain the input channel dimension and spatial resolution and (2) shortcut blocks that increase the output channel dimension while reducing the spatial resolution with a strided convolution (see FIG. 6a). DiffStride is integrated into these shortcut blocks by replacing strided convolutions by convolutions without strides followed by DiffStride. Besides, sharing DiffStride strides between the main and residual branches ensures that their respective outputs have identical spatial dimensions and can be summed (See FIG. 6b).

FIG. 6 shows a comparison side by side of the shortcut blocks in classic ResNet architectures with strided convolutions, and with DiffStride that learns the strides of the block.

The number of activations in a network depends on the strides and learning these parameters gives control over the space and time complexity of an architecture in a differentiable manner. This contrasts with previous work, as measures of complexity such as the number of floating-point operations (FLOPs) are typically not differentiable with respect to the parameters of a model and searching for efficient architectures is done via high-level exploration (e.g. introducing separable convolutions, architecture search or using continuous relaxations of complexity.

A standard 2D convolution with a square kernel of size k² and C′ output channels has a computational cost of k²×C×C′×H×W when operating on x∈ [symbol] Its memory usage—in terms of the number of activations to store—is C′×H×W. Considering a fixed number of channels and kernel size, both the computational complexity and memory usage of a convolution layer are thus linear functions of its input size H×W. This illustrates the argument made in Section 1 that downsampling does not only improve performance by discarding irrelevant information, but also reduces the complexity of the upper layers. More importantly, in the context of DiffStride the input size H^{l}×W^{l} of layer l is determined as follows:

$${H}^{l} \times {W}^{l} = ⌊ \frac{{H}^{l - 1}}{{S}_{h}^{l - 1}} + 2 \times R ⌋ \times ⌊ \frac{{W}^{l - 1}}{{S}_{w}^{l - 1}} + 2 \times R ⌋ ,$$

which is differentiable with respect to the strides at the previous layer S^{l-1}. Furthermore, it also depends on spatial dimensions at the previous layer H^{l-1}×W^{l-1}, which themselves are a function of S^{l-2}. By induction over layers, the total computational cost and memory usage are proportional to

$${\sum }_{l = 1}^{l = L} {\prod }_{i = 1}^{l} \frac{1}{{S}_{h}^{i} \times {S}_{w}^{i}} .$$

Since in the context of DiffStride the kernel size and number of channels remain constant during training, the model can be directly regularized towards time and space efficiency by adding the following regularizer to the training loss:

$$λ J ( ( {S}_{l = 1}^{l = L} = λ {\sum }_{l = 1}^{l = L} {\prod }_{i = 1}^{l} \frac{1}{{S}_{h}^{i} \times {S}_{w}^{i}} \qquad Equation 6$$

where λ is the regularization weight. Training on ImageNet with different values for λ may allow a trade-off between accuracy and efficiency in a smooth fashion. DiffStride is evaluated on eight classification tasks, both on audio and images. For each comparison, same architecture is kept and strided convolutions are replaced by convolutions with no stride followed by DiffStride. To avoid the confounding factor of downsampling in the Fourier domain, the approach described herein is compared to the spectral pooling of Rippel et al. (2015), which only differs from DiffStride by the fact that its strides are not learnable.

### III. Audio Experiments: Experimental Setup and Results

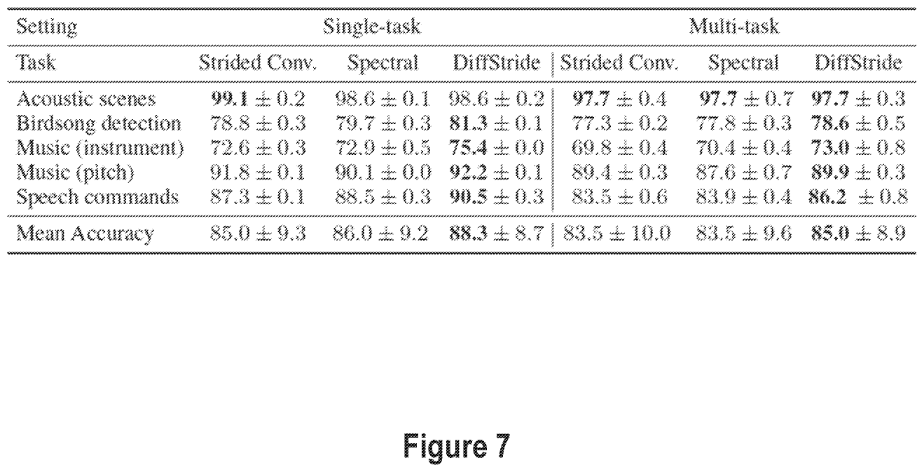

Single-task and multi-task audio classification is performed on 5 tasks: acoustic scene classification, birdsong detection, musical instrumental classification and pitch estimation on the NSynth dataset and speech command classification. The statistics of the datasets are summarized in FIG. 7. The audio sampled at 16 kHz is decomposed into log-compressed mel-spectrograms with 64 channels, computed with a window of 25 ms every 10 ms.

A 2D-CNN takes these spectrograms as inputs and alternates blocks of strided convolutions along time ((3×l) kernel) and frequency ((l×3) kernel). Each strided convolution is followed by a ReLU and batch normalization. The sequence of channels dimensions is defined as (64, 128, 256, 256, 512, 512) and the strides are initialized as ((2,2), (2,2), (1,1), (2,2), (1,1), (2,2)) for all downsampling methods. The output of the CNN passes through a global max-pooling and feeds into a single linear classification layer for single-task, and multiple classification layers for multi-task classification. As examples vary in length, models are trained on random Is windows with ADAM and a learning rate of 10⁻⁴ for IM batches, with batch size 256. Evaluation is run by splitting full sequences into Is non-overlapping windows and averaging the logits over windows.

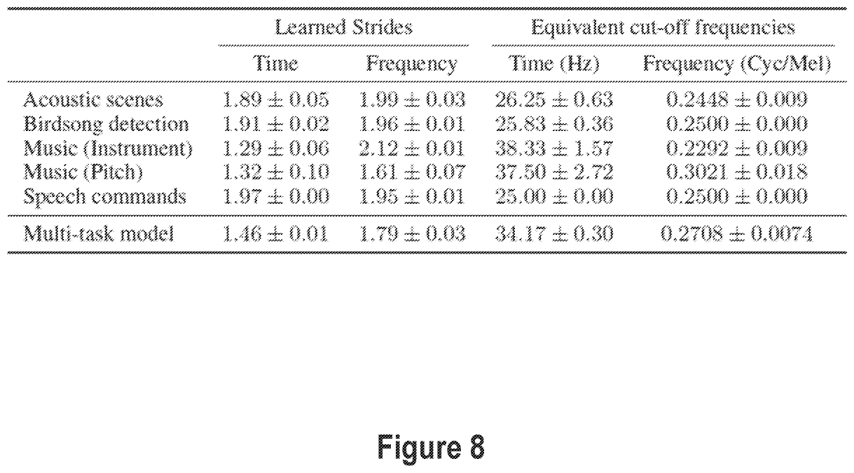

FIG. 7 summarizes the results for single-task and multi-task audio classification. In both settings, DiffStride improves over strided convolutions and spectral pooling, with strided convolutions only outperforming DiffStride for acoustic scene classification in the single task setting. FIG. 8 shows the strides learned by the first layer of DiffStride, which downsamples mel-spectrograms along frequency and time axes. Learning allows the strides to deviate from their initialization ((2, 2)) and to adapt to the task at hand. Converting strides to cut-off frequencies shows that the learned strides fall in a range showed by behavioral studies and direct neural recordings to be necessary for e.g. speech intelligibility at 25 Hz.

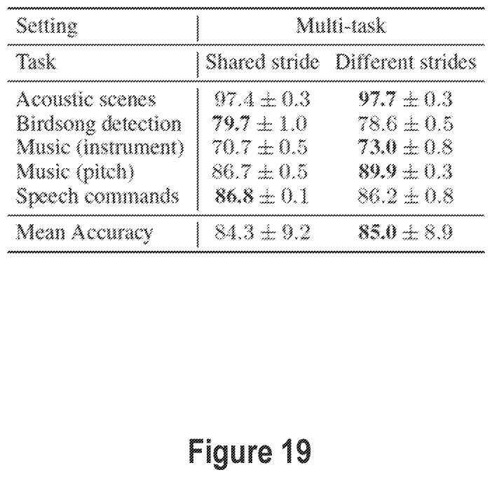

Moreover, DiffStride may learn different strides for the time and frequency axes. FIG. 19 shows the benefits of learning a per-dimension value rather than sharing strides}. Another notable phenomenon is the per-task discrepancy on NSynth, with the pitch estimation requiring faster spectral modulations (as represented by a higher cut-off frequency along the frequency axis). Finally, multi-task models do not converge to the mean of strides, but rather to a higher value that passes more frequencies not to negatively impact individual tasks.

### IV. Image Experiments: Experimental Setup and Results

ResNet architecture is used, comparing the original strided convolutions (see FIG. 6a) to spectral pooling and DiffStride (both as in FIG. 6b). Six striding configurations are randomly sampled for the three shortcut blocks of the ResNet, each stride being sampled in [l, 3], with (2, 2, 2) being the configuration of the original ResNet. The horizontal and vertical strides are initialized equally at start. These random configurations simulate cross-validation of stride configurations to: (1) showcase the sensitivity of the architecture to these hyperparameters, (2) test the hypothesis that DiffStride can benefit from learning its strides to recover from a poor initialization. On Imagenet, as inputs are bigger than CIFAR the first ResNet may be allowed to identity block to learn its strides which are 1 by default.

The three methods are benchmarked on the two CIFAR datasets. CIFAR10 consists of 32× 32 images labeled in 10 classes with 6000 images per class. The official split, with 50,000 images for training and 10,000 images, is used for testing. CIFAR100 uses the same images as CIFAR10, but with a more detailed labelling with 100 classes.

The ResNet architectures are compared on the ImageNet dataset, which contains 1,000 classes. The models are trained on the official training split of the Imagenet dataset (1.28M images) and the results are reported on the validation set (50 k images). Here, the performance is evaluated in terms of top-1 and top-5 accuracy.

All datasets are trained with stochastic gradient descent (SGD) with a learning rate of 0.1, a batch size of 256 and a momentum of 0.9. On CIFAR, models may be trained for 400 epochs dividing the learning rate by 10 at 200 epochs and again by 10 at 300 epochs, with a weight decay of 5.10⁻³. For CIFAR, random cropping is applied on the input images and left-right random flipping. On ImageNet, a weight decay of 1.10⁻³ is used for training for 90 epochs, dividing the learning rate by 10 at epochs 30, 60 and 80. Random cropping may be applied on the input images and left-right random flipping.

The results on the CIFAR datasets and Imagenet are reported in Tables 9 and 11 respectively, with the accuracy of the baseline ResNet (first row, Strided Conv.) being consistent with previous work. First, strides are observed to indeed be important hyperparameters for the performance of a standard ResNet on the three datasets, with the accuracy on CIFAR100 dropping from 66.8% average to 48.2% between the best and worst configurations. Remarkably, spectral pooling is much more robust to bad initializations than strided convolutions, even though its strides are also fixed. However, DiffStride is overall much more robust to poor choices of strides, converging consistently to a high accuracy on the three datasets, with a variance over initializations that is lower by an order of magnitude. This shows that backpropagation allows DiffStride to find a better configuration during training avoiding a cross-validation which would require 6,561 experiments for testing all combinations of strides in [l, 3] on Imagenet. Tables 18a and 18b confirm these observations on the EfficientNet-B0 architecture.

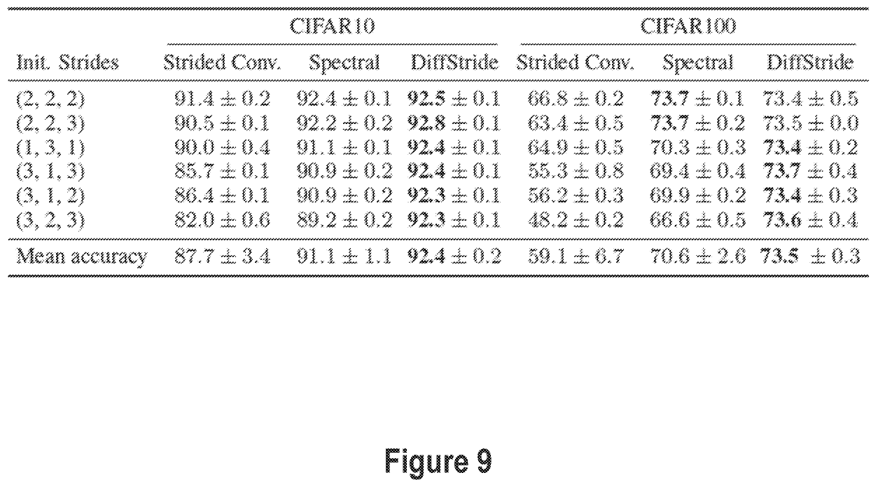

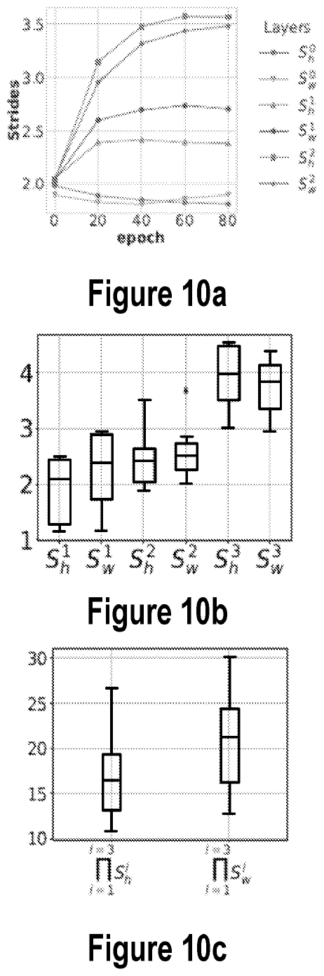

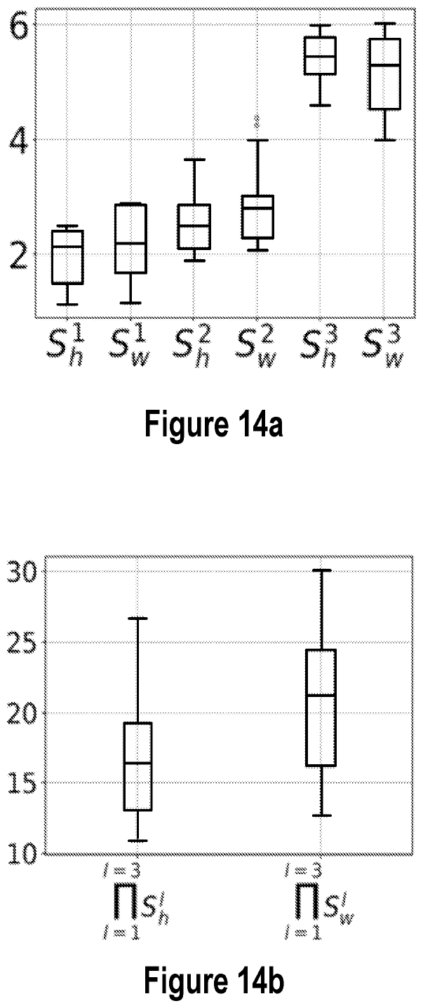

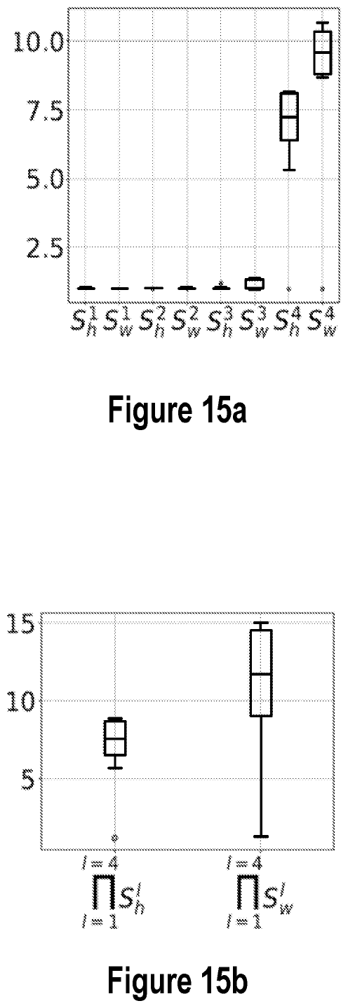

FIG. 10 illustrates the learning dynamics of DiffStride on CIFAR10, in accordance with example embodiments. FIG. 10a plots the strides as a function of the epoch for a run with the baseline (2,2,2) configuration as initialization. The strides all deviate from their initialization while converging rapidly, with the lower layers keeping more information while higher layers downsample more drastically. Interestingly, equivalence classes are discovered: despite converging to the same accuracy (as reported in FIG. 9) the various initializations yield very diverse strides configurations at convergence, both in terms of total striding factor (defined as the product of strides, see FIG. 10c) and of repartition of downsampling factors along the architecture (see FIG. 10b). Similar conclusions are obtained on CIFAR100 and Imagenet (see FIGS. 14 and 15). In the non-regularized case, it could seem counter-intuitive that minimizing the training loss yields positive stride updates, i.e. dropping more information through cropping. It highlights that loss optimization is a trade-off between preserving information (no striding, no cropping) and downscaling such that the next convolution kernel accesses a wider spatial context.

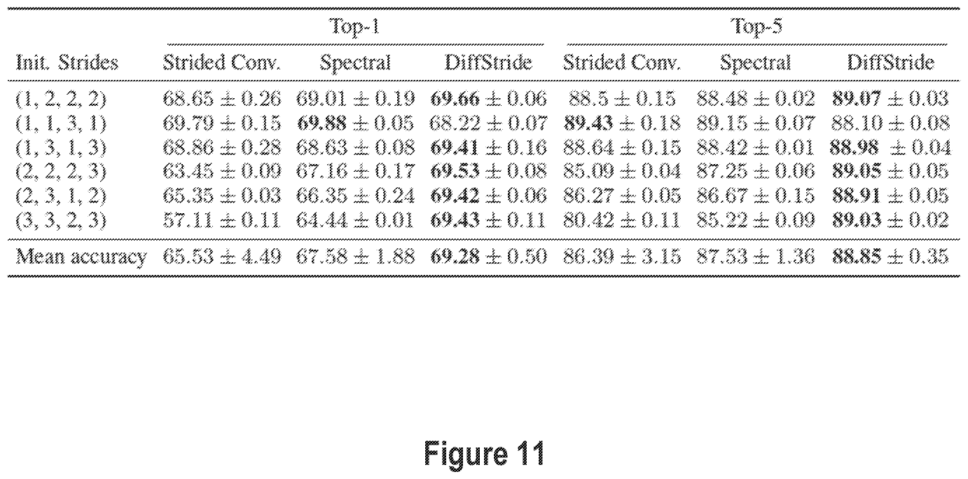

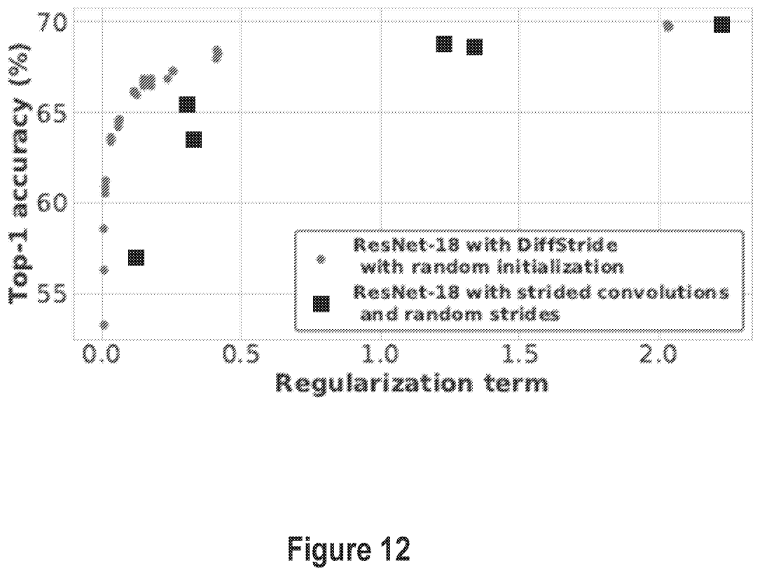

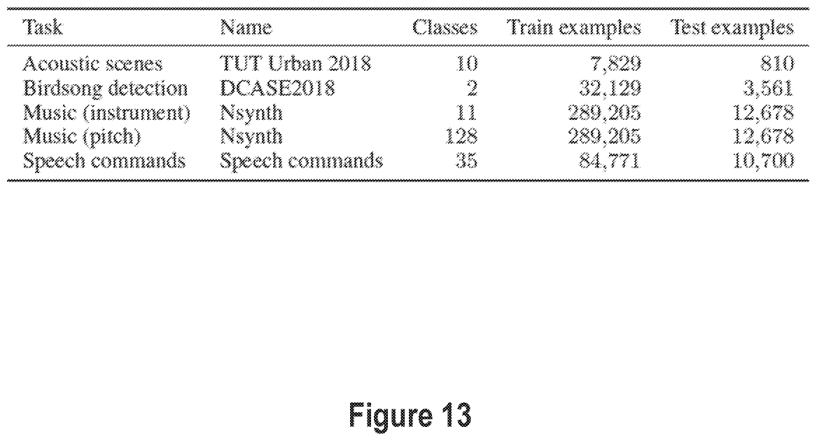

The existence of equivalence classes suggests that DiffStride can find more computationally efficient configurations for a same accuracy. Thus, DiffStride is trained on ImageNet using the complexity regularizer defined in Equation 6, with λ varying between 0.1 and 10, always initializing strides with the baseline ((1, 1), (2, 2), (2, 2), (2, 2)). FIG. 12 plots accuracy versus computational complexity (as measured by the value of the regularization term at convergence) of DiffStride. For comparison, the models with strided convolutions are plotted with the random initializations of FIG. 11, showing that DiffStride finds configurations with a lower computational cost for the same accuracy. Some of these are quite extreme, e.g. with λ=10 a model converges to strides ((10.51, 32.23), (1.20, 2.68), (1.20, 2.04), (1.96, 4.53)) for a 58.57% top-1 accuracy. When training a ResNet with strided convolutions using the closest integer strides (i.e. ((11,32), (1,3), (1, 2), (2,5))), the model converges to a 24.54% top-1 accuracy. This suggests that performing pooling in the spectral domain is more robust to aggressive downsampling, which corroborates the remarkable advantage of spectral pooling over strided convolutions when using poor strides choices in FIGS. 9 and 11 despite both models having fixed strides.

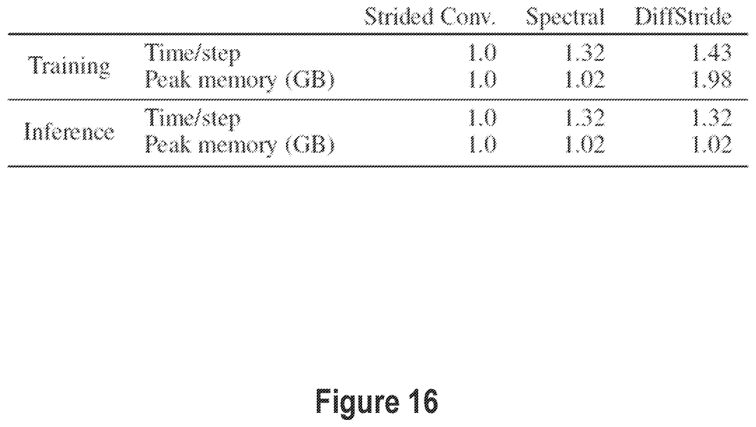

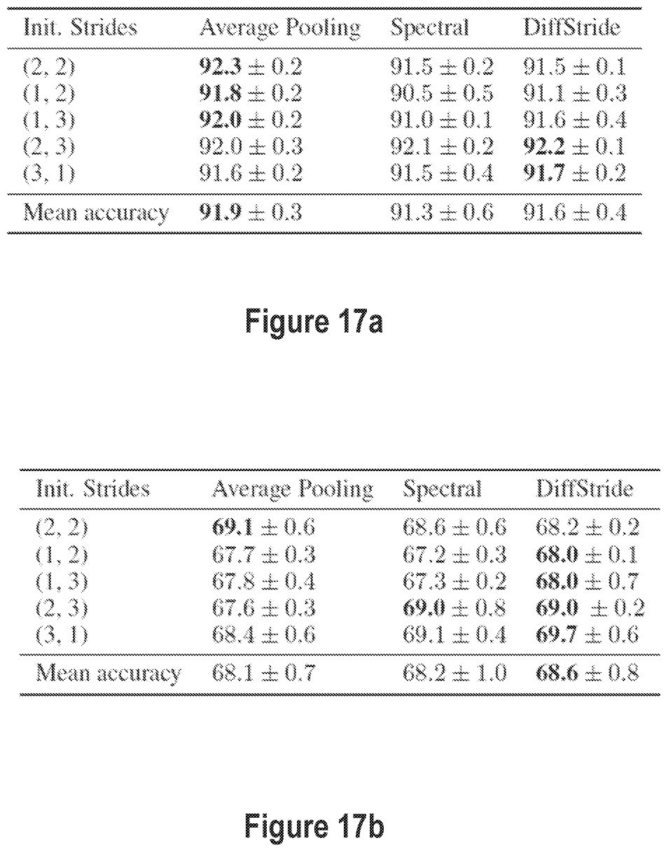

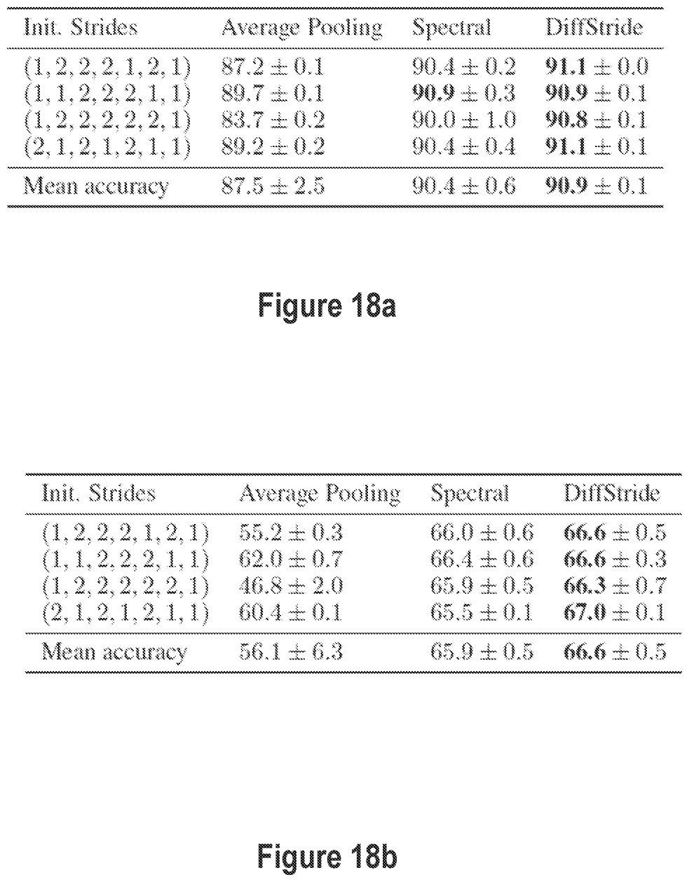

Pooling in the spectral domain comes at higher computational cost than strided convolutions as it requires (1) computing a non-strided convolution and (2) a DFT and its inverse (see FIG. 16). This could be alleviated by computing the convolution in the Fourier domain as an element-wise multiplication and summation over channels. Further improvements could be obtained by replacing the DFT by a real-valued counterpart, such as the Hartley transform, which would remove the need for complex-valued operations that may be poorly optimized in deep learning frameworks. No benefits of DiffStride were observed when training DenseNets, see FIGS. 17a and 17b. This is likely due to the limited number of downsampling layers, which may reduce the space of stride configurations to a few, equivalent ones when sampling strides in [1; 3]. Finally, some hardware (e.g. TPUs) require a static computation graph. As DiffStride changes the spatial dimensions of intermediate representations—and thus the computation graph—between each gradient update, only GPUs were used to train the models.

DiffStride, a downsampling layer with learnable strides, is introduced. As described above, audio and image classification that DiffStride can be used as a drop-in replacement to strided convolutions, removing the need for cross-validating strides. As the methods described herein can discover multiple equally-accurate stride configurations, a regularization term to favor the most computationally advantageous is also introduced.

In FIG. 14, the distributions of learned strides and the global striding factor at convergence on CIFAR100 are shown, starting from random stride initializations and in FIG. 15 the distributions of learned strides and the global striding factor at convergence on ImageNet are shown, starting from random stride initializations. On CIFAR100, equivalence classes, i.e. model that learns various stride configurations for a same accuracy, are observed. On Imagenet, even though a significant variance of the global striding factor is observed, models tend to downsample only in the upper layers. Striding late in the architecture comes at a higher computational cost, which furthermore justifies regularizing DiffStride to reduce complexity as shown in Section 3.2.

While FIG. 12 reports theoretical estimates of computational complexity based on stride configurations, both spectral pooling and DiffStride require computing a DFT and its inverse. Moreover, DiffStride requires accumulating gradients with respect to the strides during training. FIG. 16 reports the duration and peak memory usage of the multi-task architecture described in 3.1, for a single batch. Replacing strided convolutions with spectral pooling increases the wall time by 32% due to the DFT and inverse DFT, while the peak memory usage is almost unaffected. DiffStride furthermore increases the wall time (by 43% with respect to strided convolutions) as the backward pass is more expensive. Similarly, it almost doubles the peak memory usage. However, in inference, DiffStride does not need to compute and store gradients w.r.t. the strides, thus the time and space complexity become identical to that of spectral pooling.

DiffStride was also evaluated in DenseNet, especially the DenseNet-BC architecture with a depth of 121 and a growth rate of 32. The DenseNet architecture halves spatial dimensions during transition blocks. The 2D average pooling was replaced in the transition blocks by spectral pooling or DiffStride. The considered architecture for DenseNet has two downsampling steps. An experiment was run with random strides between the dense blocks on the two CIFAR datasets.

Initializing strides randomly was observed to not affect the performance of the standard Densenet-BC architecture with average pooling. Consequently, DiffStride does not improve over alternatives.

DiffStride was evaluated in an EfficientNet-B0 architecture, a lightweight model discovered by architecture search. This architecture has seven strided convolutions. ImageNet was not used to pre-train the model, but rather CIFAR was used to train the model, which explains the lower accuracy of the baseline. As the model has seven downsampling layers, the images were rescaled from 32× 32 to 128× 128, and only sample strides in [1; 2]. An experiment was run with random strides on the two CIFAR datasets. Consistently with the results obtained with a ResNet-18, spectral pooling is much more robust to poor strides than strided convolutions, with DiffStride outperforming all alternatives.

A multi-task audio classification was performed with either learning a single stride value for each DiffStride layer, or a different one for the time and frequency axes. The overall performance across tasks is improved when learning a different stride value for each dimension (See FIG. 19).

### V. Example Applications

In some embodiments, a learnable stride downsampling layer as described herein may be used in a machine learning model for image classification, audio pattern recognition, text classification machine translation, speech recognition, or a combination thereof. In some examples, a learnable stride downsampling layer may be implemented in machine learning models for audio classification, such as for acoustic scene classification, speaker identification, birdsong detection, musical instrumental classification and pitch estimation, and/or speech command classification.

In some embodiments, a learnable stride downsampling layer as described herein may be used in natural language processing. For example, a machine learning model that includes at least one downsampling layer may be used to model language (e.g., predict sentences, speech, etc.), translate a first language to a second language, generate sentences in response to operator-entered sentences (e.g., a chatbot implementation), transcribe speech to text, convert text to speech, determine answers to common sense questions, detect biased text, and/or determine fraudulent emails.

In some embodiments, a learnable stride downsampling layer as described herein may be used in image processing. For example, a machine learning model that includes at least one learnable stride downsampling layer may be used to locate objects in images, classify objects in images, caption images, restore images, generate text from text in images, recognize faces in images, and/or generate images.

In some embodiments, a learnable stride downsampling layer as described herein may be used in determining user preferences and recommending content.

In some embodiments, a learnable stride downsampling layer as described herein may be used in predicting market directions.

In some embodiments, a learnable stride downsampling layer as described herein may be used in predicting the onset of preventative diseases.

In some embodiments, a learnable stride downsampling layer as described herein may be used in determining diseases from patient x-rays or other aspects of patient medical records.

In some embodiments, a learnable stride downsampling layer as described herein may be used for controlling or assisting operation of an autonomous agent, e.g., to determine planned trajectories for a robot.

In some embodiments, a learnable stride downsampling layer as described herein may be used in a machine learning model for video processing, such as to generate captions to videos or to add sounds to videos.

### VI. Example Technical Benefits

In some examples, a machine learning model that includes a learnable stride downsampling layer may have the potential to determine more accurate predictions than a machine learning model that includes a strided layer with a manually determined stride hyperparameter. In particular, deep machine learning models may be traditionally implemented using many layers to progressively extract features from an input to determine a desired property, and some of these many layers may include a manually determined stride hyperparameter. Because the hyperparameters of each layer may affect the results (and the optimal manually determined stride hyperparameter) of the subsequent layer and so on, manually determining the optimal stride hyperparameter for each of these layers may thus be time-consuming, if not impossible. Thus, the learnable stride downsampling layer described herein may have the potential to determine more accurate predictions.

In some examples, a machine learning model that includes a learnable stride downsampling layer may be easier and faster to train and implement than a machine learning model that includes a strided layer with a manually determined stride hyperparameter. For example, some machine learning models that implement at least one strided layer with a manually determined stride hyperparameter may have a smaller value for a manually determined stride hyperparameter to avoid excessive downsampling. Because a smaller value for the manually determined stride hyperparameter may result in more output features (e.g., less downsampling), a machine learning model that includes layers with a manually determined stride hyperparameter may take longer to train and implement. Whereas, learnable stride downsampling layers may learn the optimal stride values during training and implement the determined stride values during inference.

In some examples, a machine learning model that includes a learnable stride downsampling layer may be easier to implement than a machine learning model that includes a strided layer with a manually determined stride hyperparameter. Some manually determined stride parameters may be determined using a grid search, which may be a brute force way to obtain the optimal stride hyperparameter value. To determine the optimal stride hyperparameter value in this way, a machine learning model may need to be retrained many times, experimenting with many different variations of values for the stride hyperparameter. Thus, a learnable stride downsampling layer that determines the optimal value of the stride during training may be much easier to implement than a machine learning model that includes a strided layer with a manually determined stride hyperparameter.

In some examples, a machine learning model that includes an learnable stride downsampling layer may use less memory during training (and subsequently during inference) compared to a model that includes a strided layer with a manually determined stride hyperparameter, because the value of the stride for a learnable stride downsampling layer may converge to a larger value than the value that the manually-determined stride hyperparameter would be set to, as mentioned above.

In some examples, a machine learning model that includes a learnable stride downsampling layer in lieu of a strided layer with a manually determined stride hyperparameter may be able to converge to a stride value which enables determining accurate predictions even when the stride value for the learnable stride downsampling layer is initiated to a sub-optimal initial random value.

### VII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method of training a machine learning model, the method comprising:
receiving training data for the machine learning model, wherein the training data comprises a plurality of batches;
applying a downsampling layer of the machine learning model to the plurality of batches of the training data to determine a stride comprising a learnable parameter for the downsampling layer, wherein applying the downsampling layer of the machine learning model to a batch of the training data comprises:
projecting an input in a spatial domain to a Fourier domain;
constructing a mask in the Fourier domain based on a current value of the stride and dimensions of the input;
applying the mask as a low-pass filter to the projected input to produce a tensor in the Fourier domain;
cropping the tensor based on the mask; and
transforming the cropped tensor to the spatial domain; and
outputting, based on the determined stride, a trained machine learning model.

2. The method of claim 1, wherein applying the downsampling layer of the machine learning model to the batch of the training data further comprises:
before cropping the tensor based on the mask, applying a stop gradient operator to the mask.

3. The method of claim 1, wherein the mask is further based on a smoothing hyperparameter.

4. The method of claim 3, wherein the stride comprises an additional learnable parameter, wherein the input comprises a tensor having at least a first dimension and a second dimension, wherein cropping the tensor based on the mask results in the cropped tensor having at least dimensions of (i) the first dimension of the input divided by the learnable parameter plus twice the value of the smoothing hyperparameter and (ii) the second dimension of the input divided by the additional learnable parameter plus twice the value of the smoothing hyperparameter.

5. The method of claim 3, further comprising applying one or more additional downsampling layers of the machine learning model to one or more additional inputs for the plurality of batches of the training data to determine one or more additional strides each comprising an additional learnable parameter for the one or more additional downsampling layers, wherein applying each additional downsampling layer comprises applying an additional mask based on an additional smoothing hyperparameter, wherein each of the smoothing hyperparameter and the additional smoothing hyperparameters have a same value.

6. The method of claim 1, further comprising applying an additional downsampling layer of the machine learning model to an additional input for the plurality of batches of the training data to determine an additional stride comprising an additional learnable parameter for the downsampling layer, wherein the applying the additional downsampling layer comprises constructing an additional mask based on a current value of the additional stride and dimensions of the additional input, wherein the current value of the stride differs from the current value of the additional stride.

7. The method of claim 1, wherein the stride comprises an additional learnable parameter, wherein the input comprises a tensor including a first dimension and a second dimension, wherein the learnable parameter has a value between one and the first dimension, and wherein the additional learnable parameter has a value between one and the second dimension.

8. The method of claim 1, wherein the input comprises a tensor including a first dimension and a second dimension, wherein the learnable parameter corresponds to the stride in the first dimension and the second dimension, and wherein the learnable parameter has a value between one and the lesser of the first dimension and the second dimension.

9. The method of claim 1, further comprising applying a convolution layer without stride of the machine learning model to an additional input for the plurality of batches of the training data to determine the stride comprising the learnable parameter for the downsampling layer, wherein the convolution layer is directly followed by the downsampling layer.

10. The method of claim 1, wherein applying the mask as a low-pass filter to the projected input to produce a tensor in the Fourier domain comprises calculating, using element-wise multiplication between the low-pass filter and the projected input, the tensor in the Fourier domain.

11. The method of claim 1, wherein projecting the input in the spatial domain to the Fourier domain comprises computing a discrete Fourier transform of the input from the spatial domain.

12. The method of claim 1, wherein transforming the cropped tensor to the spatial domain comprises computing an inverse discrete Fourier transform of the cropped tensor in the Fourier domain.

13. (canceled)

14. The method of claim 1, wherein the method further comprises, for a first batch of the training data, generating a random value for the current value of the stride.

15. The method of claim 14, wherein the method further comprises determining the current value of the stride for a second batch of the training data based on calculating, based on backpropagation and the random value generated for the first batch of the training data, a refined current value of the stride.

16. The method of claim 1, wherein the input is two-dimensional, wherein the mask in the Fourier domain is an outer product of a horizontal mask and a vertical mask, wherein the horizontal mask and the vertical mask are derived from adaptive span attention.

17. The method of claim 1, wherein the input is three-dimensional, wherein the mask in the Fourier domain is an outer product of three one-dimensional masks derived from adaptive span attention.

18. The method of claim 1, wherein the input has a plurality of channels, wherein applying the mask as the low-pass filter to the projected input to produce the tensor in the Fourier domain comprises applying the mask to each of the plurality of channels.

19. The method of claim 1, wherein applying the downsampling layer of the machine learning model to a batch of the training data further comprises using a complexity regularizer comprising a regularization weight.

20. A method of applying a machine learning model that includes a downsampling layer with a learned value of a stride, the method comprising:
projecting, by at least one computing device, an input provided to the downsampling layer of the machine learning model in a spatial domain to a Fourier domain;
constructing, by the at least one computing device, a mask in the Fourier domain based on the learned value of the stride of the downsampling layer of the machine learning model and dimensions of the input;
applying, by the at least one computing device, the mask as a low-pass filter to the projected input to produce a tensor in the Fourier domain;
cropping, by the at least one computing device, the tensor based on the mask;
transforming, by the at least one computing device, the cropped tensor to the spatial domain; and
generating, by the at least one computing device, an output based on the transformed cropped tensor.

21-22. (canceled)

23. A system comprising:
a processor; and
a non-transitory computer-readable medium having stored thereon instructions that, when executed by the processor, cause the processor to perform operations comprising:
receiving training data for the machine learning model, wherein the training data comprises a plurality of batches;
applying a downsampling layer of the machine learning model to the plurality of batches of the training data to determine a stride comprising a learnable parameter for the downsampling layer, wherein applying the downsampling layer of the machine learning model to a batch of the training data comprises:
projecting an input in a spatial domain to a Fourier domain;
constructing a mask in the Fourier domain based on a current value of the stride and dimensions of the input;
applying the mask as a low-pass filter to the projected input to produce a tensor in the Fourier domain;
cropping the tensor based on the mask; and
transforming the cropped tensor to the spatial domain; and
outputting, based on the determined stride, a trained machine learning model.

24. (canceled)
